(19) United States
(12) Patent Application Publication
(10) Pub. No.: US 2009/0319937 A1
(43) Pub. Date: Dec. 24, 2009

(54) INTEGRATED MULTI TABBING

(75) Inventors: Mark E. Molander, Cary, NC (US); Vincent C. Conzola, Raleigh, NC (US); Todd M. Eischeid, Cary, NC (US)

Correspondence Address: IBM CORPORATION (ACCSP);c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/144,407

(22) Filed: Jun. 23, 2008

(51) Int. Cl. G06F 3/048

(52) U.S. Cl. 715/777

(57) ABSTRACT

A method for extending known single-select mutually-exclusive tabs to simultaneously include multiple selection tabs with easy surfaced user controls. These controls enable the user to quickly and easily select and unselect one or more tabs in the tab group.

### TECHNICAL FIELD

The present disclosure generally relates to user-manipulable controls in software user interfaces. More specifically it expands upon a tabbed notebook control for switching among various views.

### BACKGROUND

Tabbing controls are becoming increasingly pervasive in software User Interfaces (UIs). For instance, current-day web browsers such as Internet Explorer® (IE) and Firefox® have recently adding tabbing as a quick and convenient way to switch among open pages. Additionally, version 5.0 of LOTUS NOTES® included Inbox tabbing. Tab controls are also used in more general software applications to switch among views of different properties, etc. A major advantage of tabs is that they consume relatively little screen space, afford the ability to quickly navigate to another panel or view, and can utilize the same screen area to show many different views.

A shortcoming of tabs is that they are used ubiquitously in implementations which lack full user utility. For example, tab relational context doesn't provide a very rich UI structure. Furthermore, the majority of tabs only display text labels. Occasionally a status indicator has been added to a tab. Tab controls typically act as toggles, i.e., the entire tab's surface is a hot spot to click, hiding the contents of the previously active tab and displaying the contents of the tab that the user activates. These controls are toggles because the contents associated with a tab are either visible or hidden.

### SUMMARY

The essence of this invention is to extend the single-select mutually-exclusive tab concept to include the ability to allow multiple tabs to be active simultaneously, while affording a simple method for the user to do so. The novelty of this invention includes:
a. Access to all combinations and permutations of the tab selections. The user can create combined views simply by activating the contents of multiple tabs. This would eliminate the need to create new tabs specifically to represent the combined views of other tabs. The views would be combined in an intelligent way by the software application and this method would differ depending on the application.
b. Easy and natural way for user to “drill wider”—to a more end-to-end view as more tabs get selected. Just click another part (multi-select part) of another tab to select that tab to be added to the view.
c. In a preferred embodiment, multi tabbing displays and provides access to additional information within the same view but with richer cross-set relationships.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The novelty of the disclosure will be understood by those skilled in the art by reference to the accompanying figures in which:

FIG. 1 is a graphical user interface (GUI) of a current-day tab control illustrating the “Servers” tab being active and showing an error with the blade server in Slot 4;

FIG. 2 is a graphical user interface (GUI) of a current-day tab control illustrating the “Storage” tab being active and showing detail about applicable storage.

FIG. 3 is a graphical user interface (GUI) of a preferred embodiment of the present invention illustrating multi select control of the present invention; the contents of the “Servers” tab and the “Storage” tab have been intelligently combined by the application to present the user with a combined view of the two.

FIG. 4 is a graphical user interface (GUI) of a preferred embodiment of the present invention illustrating the utilization of tabs contextually related to each other;

FIG. 5 is a graphical user interface (GUI) of a preferred embodiment of the present invention illustrating the “Servers” tab and “Storage” tab intelligently combined by the application; and

FIG. 6 is a flow diagram of the utilization of multi tabbing of the present invention.

### DETAILED DESCRIPTION

The present invention provides a method, apparatus and program storage device for multiple active tab functionality integrated into a tabbed view control on a software graphical user interface. One possible embodiment is illustrated in the accompanying drawings.

One embodiment involves troubleshooting hardware problems in a datacenter environment. The current invention would allow the user to combine individual views of hardware into a more integrated and holistic view, affording a better understanding of how individual components relate to one another.

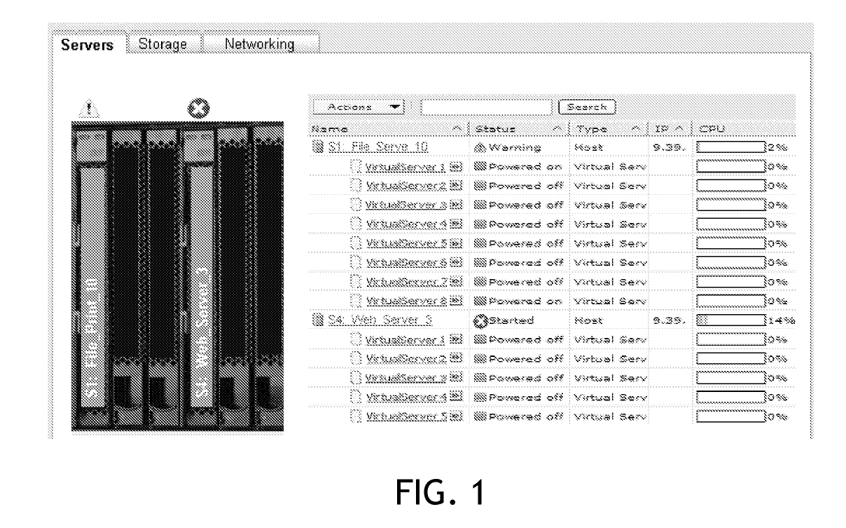

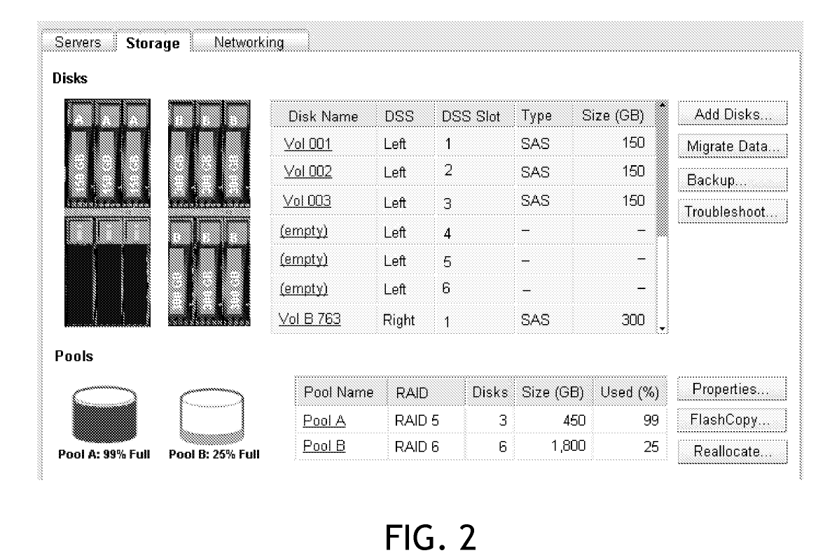

Here is one example. Suppose there is a set of views, implemented in a tab view control that includes a view of servers and a view of storage. In FIG. 1, it is apparent that there is an error associated the blade server in the 4th slot: “Web_Server_{—}3”, but the source of the problem remains unclear from this narrow perspective. The user then explores a bit more by clicking on the main part of the “Storage” tab, FIG. 1 (not the top of it, but where the text is). This replaces the previous view with a new view, as is the current art for tab view controls. The user now sees from the storage-only tabbed view that “Pool A” is full (FIG. 2). The user now is wondering how and if “Pool A” relates to the web server blade, like could the problems be correlated? Using this multi-tab invention, the user could select the “Servers” tab in such a way as to NOT replace the “Storage” view. This could be highly surfaced on the tab itself. In the example below it is shown by the top colored bar on the tab, which is the multi-select touch point of the tab.

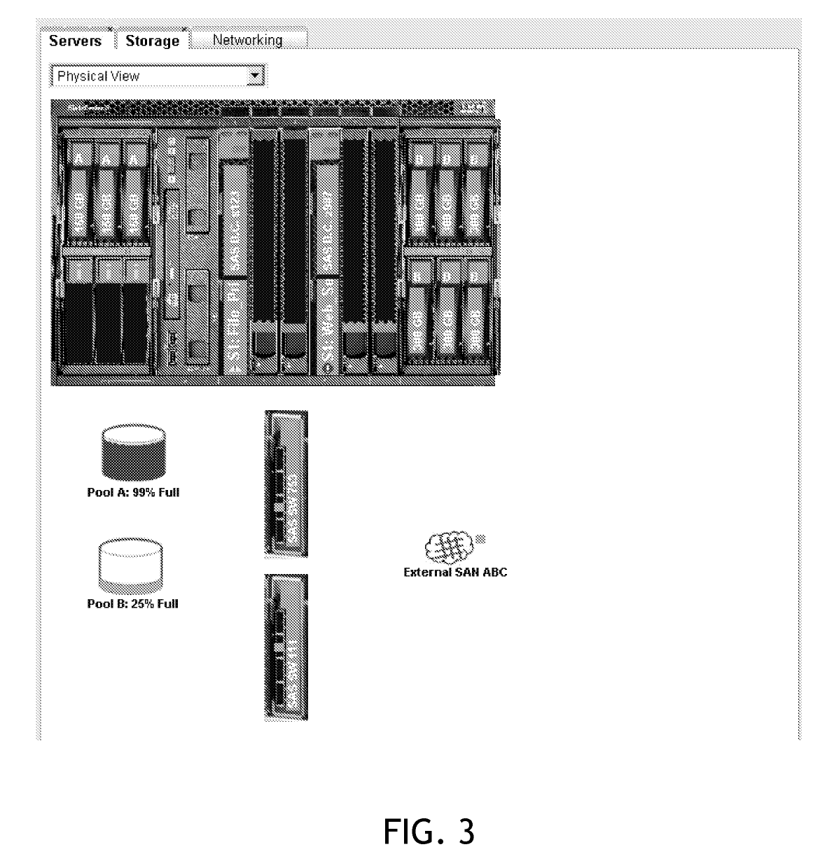

There are additional embodiments of this type of multi-select control, including but not limited to a check box on the tab, a drop-down selector as part of the tab, or via a right-click context menu choice for multi-tabbing (FIG. 3).

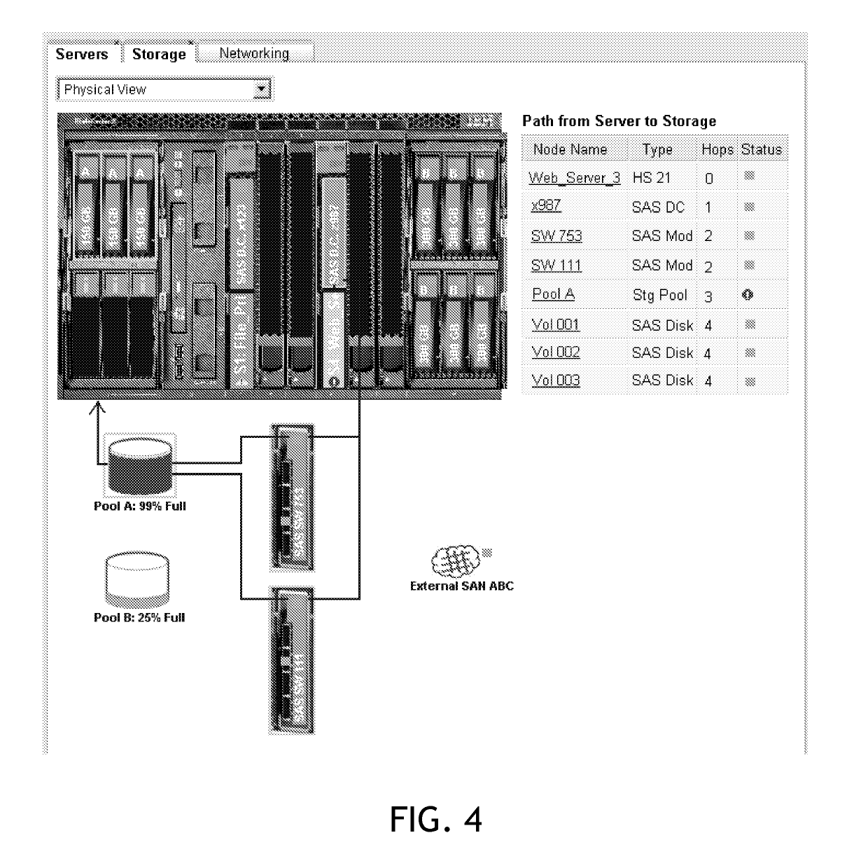

Finally, (FIG. 4) the user could next select the server to get an end-to-end view from the server to the storage and all the nodes in between, made possible and quickly accessible by this invention (one tabbed click from the point of context of either one of the single-select tab cases above, either from “Servers” or from “Storage”).

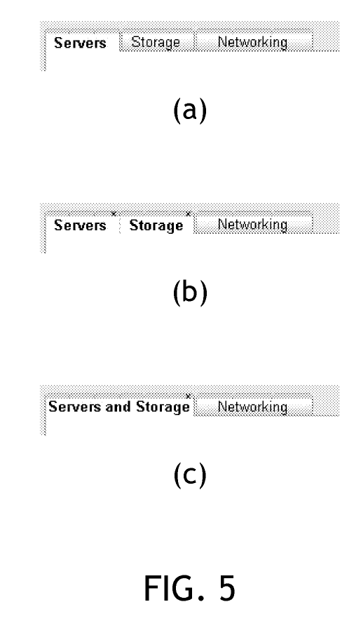

In a further embodiment of the present invention (FIG. 5), two or more containers may be utilized, each containing multiple tab selectors. For example, a resource- or hardware-based tab group might span a particular dimension, as previously illustrated in FIGS. 1-4 (servers, storage, networking) and a more task-oriented tab group could span another. It would be possible to simultaneously activate or select a single tab in each container, thus creating a combined view in that manner. So, for example, the task-oriented tabs might have tabs for “Events”, “Health”, “Troubleshoot”, and the like. If properly designed, such a UI could surface fewer navigation nodes to the user than traditional UIs, and the task-oriented tabs matrixed with the resource-oriented tabs complement each other.

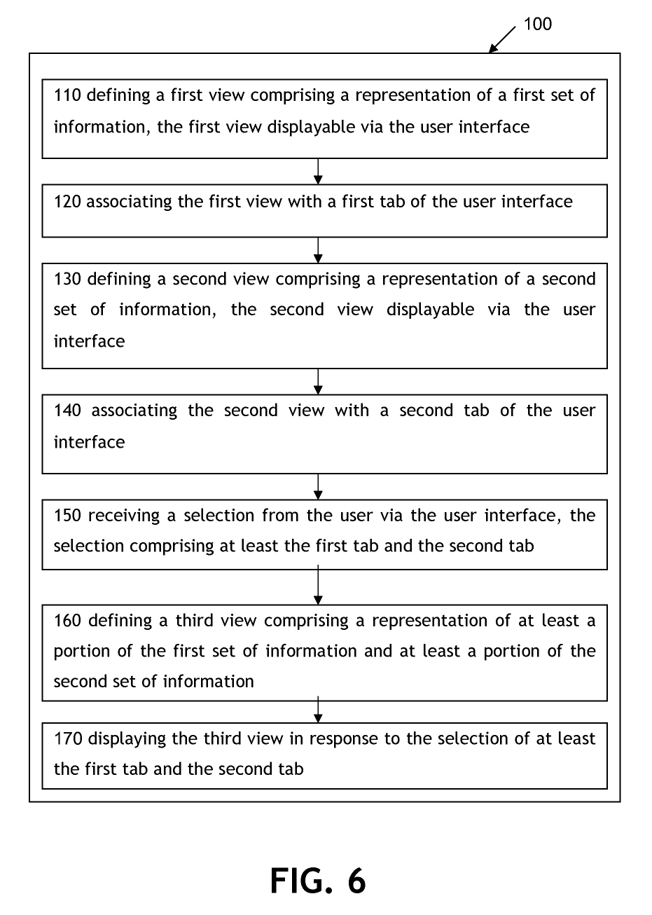

Referring to FIG. 6, a method for providing a user interface 100 is depicted. Method 100 may define a first view comprising a representation of a first set of information, the first view displayable via the user interface 110. Method 100 may associate the first view with a first tab of the user interface 120. Method 100 may define a second view comprising a representation of a second set of information, the second view displayable via the user interface 130. Method 100 may associate the second view with a second tab of the user interface 140. Method 100 may receive a selection from the user via the user interface, the selection comprising at least the first tab and the second tab 150. Method 100 may define a third view comprising a representation of at least a portion of the first set of information and at least a portion of the second set of information 160. Method 100 may display the third view in response to the selection of at least the first tab and the second tab 170.

This invention is applicable beyond the server-storage examples described above. Multi-select tabbing could also be used for map applications, with tabs for “Roads”, “Satellite”, and “Terrain”. Users could pick and choose one of more map tabs based on which map “layers” were most useful to them, and not have screen-wasteful and complicating “Hybrid” tabs to do that function. Another example would be for network management, with tabs for “Image”, “Tabular”, and “node-link”. Again, users could pick one or more tabs, with for example the “Tabular”+“node-link” tabs being selected could show a hybrid view of a node-link topology view intermixed with embedded mini tabular displays for particular nodes (e.g., event table, attribute-value table). In this network management tabbing example the multi-tabbing is not a simple layering as in the map example. The combination of multiple tabs presents information that's optimized for the multi-selection and how best to server the needs of the user.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A method for providing a user interface, comprising:
defining a first view comprising a representation of a first set of information, the first view displayable via the user interface;
associating the first view with a first tab of the user interface;
defining a second view comprising a representation of a second set of information, the second view displayable via the user interface;
associating the second view with a second tab of the user interface;
receiving a selection from the user via the user interface, the selection comprising at least the first tab and the second tab;
defining a third view comprising a representation of at least a portion of the first set of information and at least a portion of the second set of information; and
displaying the third view in response to the selection of at least the first tab and the second tab.
